(19) United States
(12) Patent Application Publication
(10) Pub. No.: US 2002/0175190 A1
(43) Pub. Date: Nov. 28, 2002

(54) Valve, in particular pressure reducing valve

(76) Inventor: Alois Schwarz, Kirchdorf/Tirol (AT)

Correspondence Address: LERNER AND GREENBERG, P.A., POST OFFICE BOX 2480, HOLLYWOOD, FL, 33022-2480, US

(21) Appl. No.: 10/199,587

(22) Filed: Jul. 19, 2002

Related U.S. Application Data
(63) Continuation of application No. PCT/AT01/00017, filed on Jan. 23, 2001.

(30) Foreign Application Priority Data
Jan. 25, 2000 (AT) A 103/2000

(51) Int. Cl. G01F 11/10

(52) U.S. Cl. 222/368

(57) ABSTRACT

The valve, which is particularly suitable as a pressure reducing valve, has a housing, with a cylindrical chamber for a rotor, an inlet for a pressurized medium, and an outlet for the escaping reduced pressure medium. The housing and the rotor are made from a ceramic material and the rotor is a cylindrical body, which has, on the outer surface thereof, a number of recesses which are arranged at a distance from each other, in the direction of flow. The areas of the outer surface of the rotor, between the recesses and the inner surface of the cavity, within the housing and the end surfaces of the rotor and the end surfaces of the housing together form a seal.

### CROSS-REFERENCE TO RELATED APPLICATIONS

This application is a continuation of copending International Application No. PCT/AT01/00017, filed Jan. 23, 2001, which designated the United States and which was not published in English.

### BACKGROUND OF THE INVENTION

### FIELD OF THE INVENTION

The present invention relates to a valve, in particular a pressure reducing valve, with a housing that is formed with a cylindrical cavity wherein a rotor is rotatably supported. The housing further has an inflow duct for a medium which is under pressure and with an outflow duct for the medium which flows out with reduced pressure.

In a multitude of technical plants, it is necessary to reduce the pressure of media, such as liquids or gases, which are under high pressure. This applies, for example, to the transport of gases which are conveyed under high pressure over long distances. It also applies to water supply systems, wherein the water is under high pressure because the supply of water even to customers located at a high level must be ensured. When these media are dispensed to consumers, however, the existing pressure must be reduced to a pressure corresponding to the requirements. In order to satisfy this condition, valves, in particular pressure-reducing valves, through which the media are guided, are arranged in systems of this kind. Further fields of use are industrial installations containing a gaseous or liquid medium which is under high pressure and the pressure of which has to be reduced, such as refrigerating plants, compressed—air supply systems and hydraulic installations.

In the installations known hitherto, wherein pressure reduction is brought about, however, this means that the pressure energy contained in the medium is thereby converted, in particular, into heat which is not utilized and is therefore wasted.

### SUMMARY OF THE INVENTION

It is accordingly an object of the invention to provide a pressure-reducing valve, which overcomes the above-mentioned disadvantages of the heretofore-known devices and methods of this general type and provides for a valve device, by way of which pressure energy contained in media can be converted into kinetic energy and, if appropriate, into electrical energy.

For many years, turbines have been known. The rotors of turbines are set in rotation by means of flowing media, in particular by means of water. The energy of flow can be converted to other kinetic energy and electrical energy can be generated by means of electrical generators. However, known turbines cannot be used as shut-off valves, since they cannot bring about a shut-off of the medium which is under pressure. The reason for this is that known turbines are produced from metal, and therefore, because of the thermal-expansions, it is not possible to achieve an accuracy of fit of the rotor in the casing such that they can also act as a shut-off valve.

The object on which the present invention is based is, therefore, to provide a valve with a rotor arranged in a cylindrical cavity, by means of which valve and which rotor the function of a shut-off valve and the function of a pressure reducing valve are fulfilled, while the energy occurring during the functioning of a pressure reducing valve can be recovered.

With the foregoing and other objects in view there is provided, in accordance with the invention, a valve, specifically a pressure-reducing valve, comprising:

a casing of ceramic material having a cylindrical cavity formed therein with a peripheral cavity surface and end faces,

an inflow duct for a pressurized medium communicating with the cavity and an outflow duct for the medium flowing out with reduced pressure communicating with the cavity;

a rotor of ceramic material received in the cylindrical cavity;

the rotor being a cylindrical body with end faces and a peripheral rotor surface formed with a multiplicity of recesses at a spacing distance from one another in a direction of rotation, the peripheral rotor surface, in regions thereof between the recesses, sealingly bearing against the peripheral cavity surface in the casing, and the end faces of the rotor sealingly bearing against the end faces of the casing.

In other words, the objects of the invention are achieved, according to the invention, in that the casing and the rotor are produced from a ceramic material, and in that the rotor is formed as a cylindrical body which is produced on its outer surface with a multiplicity of spaced-apart recesses. The outer surface regions which are located between the recesses come to bear against the inner surface of the cavity located in the casing, and the end faces of the rotor come to bear sealingly against the end faces of the casing.

Since ceramic material does not undergo any critical thermal stresses, both the rotor and the casing can be produced with a very high accuracy of fit, with the result that this valve can perform the function of a shut-off valve in the event of a blockage of the shaft of the rotor. By contrast, as soon as the shaft of the rotor is freed, the rotational speed of the shaft being capable of being regulated electronically, this valve performs the function of a reducing valve. As a further consequence, the electrical energy transmitted by the shaft of the rotor can be recovered, and, in particular an electrical generator can be operated. The energy recovered by the electrical generator can be stored in an accumulator. It may, however, also be converted into heating energy which, for example, is fed into a thermal store.

Preferably, the recesses formed in the rotor are configured as radially oriented grooves. In a preferred embodiment, the grooves are not aligned with the radius, but they lean slightly forward into the flow. According to a preferred embodiment, the recesses are produced with lateral cheeks, so that they are open only radially outward. Furthermore, preferably, the inflow duct and the outflow duct are arranged approximately diametrically to one another. Moreover, the rotor may be designed with a central recess, to which a sleeve produced from elastic material is inserted.

In accordance with a concomitant feature of the invention, the casing is a two-part casing, in particular square body, one part being produced with the cavity and the inflow duct and also with the outflow duct, and the other part being designed as a cover plate.

Other features which are considered as characteristic for the invention are set forth in the appended claims.

Although the invention is illustrated and described herein as embodied in a valve, in particular pressure-reducing valve, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a first embodiment of a valve according to the invention in an exploded axonometric illustration;

FIG. 2 shows the same valve in a section taken along the line II-II of FIG. 3 and viewed in the direction of the arrows;

FIG. 3 shows the same valve in a section taken along the line III-III of FIG. 2 and viewed in the direction of the arrows;

FIG. 4 is an exploded axonometric view of a second embodiment of the valve according to the invention;

FIG. 5 shows the valve according to FIG. 4 in a section taken along the line V-V of FIG. 6 and viewed in the direction of the arrows;

FIG. 6 shows the valve according to FIG. 5 in section along the line VI-VI of FIG. 5 and viewed in the direction of the arrows;

FIG. 7 shows a component of the valve according to FIG. 4 in axial section and in an exploded illustration;

FIG. 8 shows a further component of this valve in section along the line VIII-VIII of FIG. 9 and viewed in the direction of the arrows; and

FIG. 9 shows this further component in section along the line IX-IX of FIG. 8 and viewed in the direction of the arrows.

### DESCRIPTION OF THE PREFERRED EMBODIMENTS

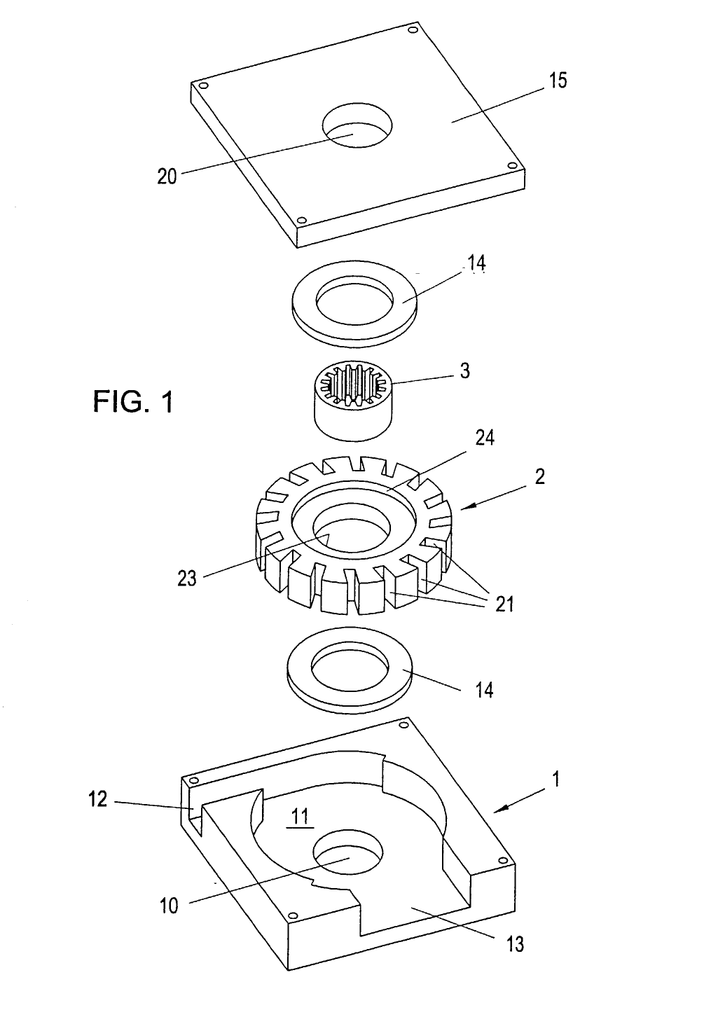

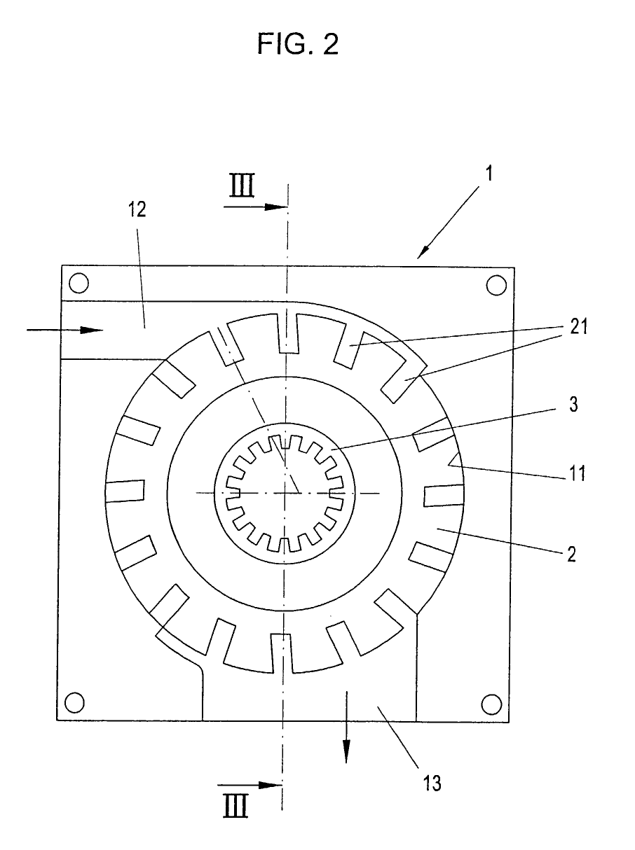

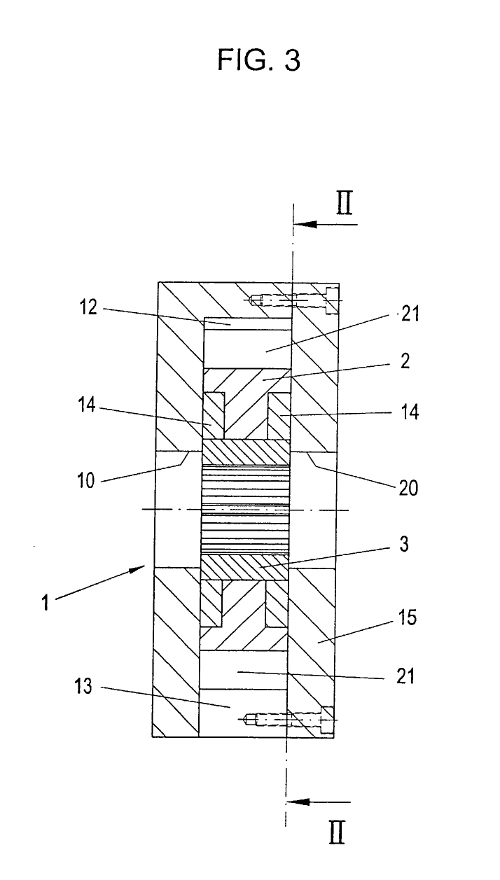

Referring now to the figures of the drawing in detail and first, particularly, to FIGS. 1-3 thereof, the valve has a housing or casing 1 which is produced with an approximately cylindrical cavity 11, with an inflow duct 12, and with an outflow duct 13. The casing 1 can be closed off with a cover 15.

A cylindrical rotor 2 is inserted into the cylindrical cavity 11, with two sealing disks 14 interposed. The rotor 2 is produced on its outer periphery with a multiplicity of radially oriented slot-like cavities 21. For receiving the sealing rings 14, the rotor 2 is provided with cylindrical recesses 24 on its two end faces. A coupling sleeve 3 is inserted into a central bore 23 of the rotor 2. The coupling sleeve 3 is formed on its radially inner side with grooves or splines for coupling to a shaft. The shaft passes through the casing 1 in a bore 10 and the cover 15 in a bore 20.

Both the casing 1 and the cover 15 and the rotor 2 are produced from ceramic material. Since the ceramic material is not subject to any critical thermal expansions, the recesses 11 and the rotor 2 can be produced with an accuracy of fit such that no medium can flow through between these two components. Since, by contrast, the coupling sleeve 3 is produced from an elastic material, actuating forces acting on the shaft are absorbed by the coupling sleeve 3, so that they do not take effect on the rotor 2 or the latter is mounted in a floating manner in the cavity 11.

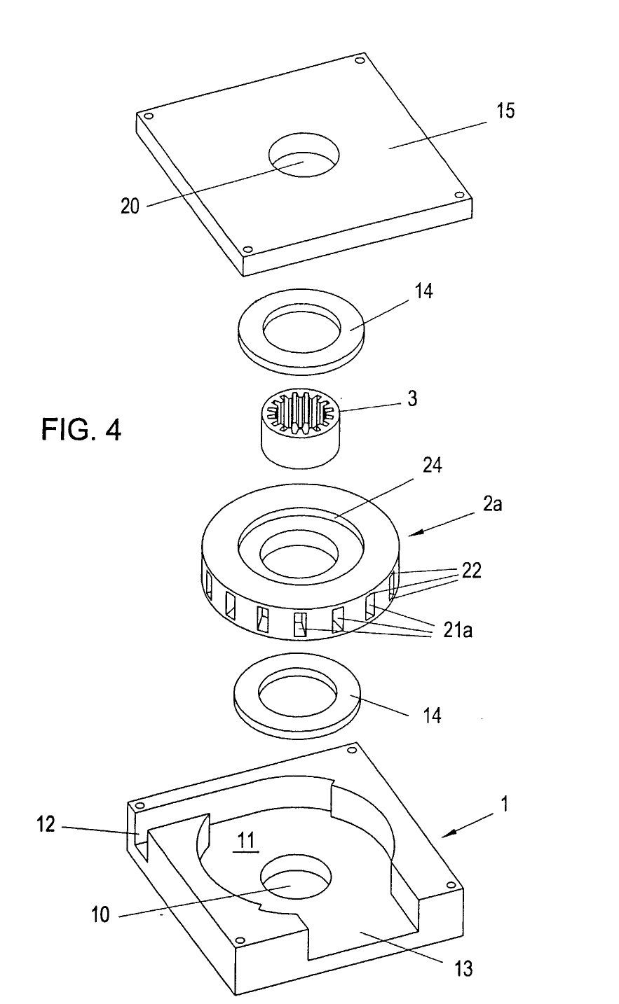

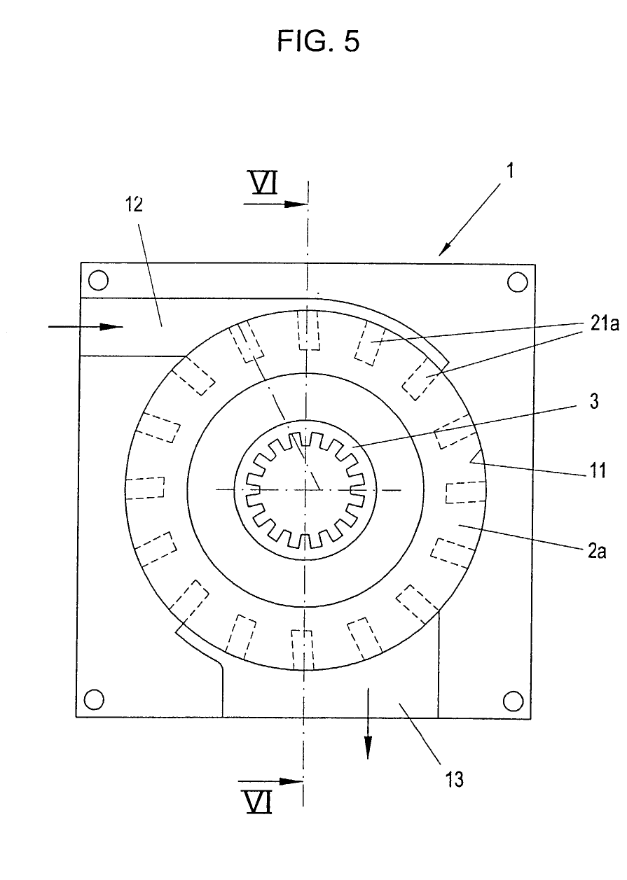

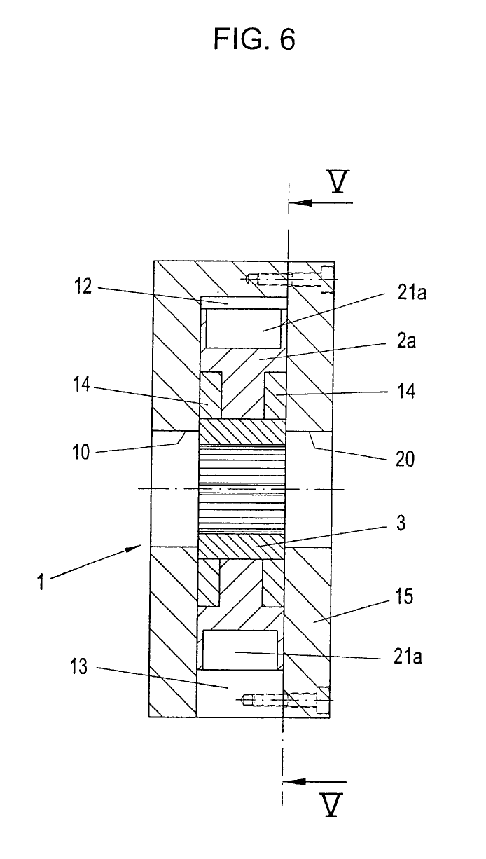

The second exemplary embodiment illustrated in FIGS. 4 to 6 differs from the first exemplary embodiment in that the recesses 21a of the rotor 2 are closed off by lateral cheeks 22, with the result that the recesses 21a are open only radially outward.

When this device is in operation, the duct 12 of the casing 1 is connected to a line containing medium which is under pressure. As long as the rotor 2 is blocked, this device performs the function of a shut-off valve. However, as soon as medium is to flow out with reduced pressure into a consumer line via the outflow duct 13, the rotor 2, 2a is released, with the result that the medium takes effect on the flanks of those grooves 21, 21a which are located in the inflow duct 12, with the result that the rotor 2, 2a is set in rotation. The medium located in the grooves 21, 21a thereby passes with reduced pressure into the outflow duct 13. The rotational energy generated by the rotor 2, 2a is transmitted via the shaft coupled to the rotor 2, 2a, with the result that it can be recovered. Preferably, by means of the shaft, an electrical generator is driven, the electrical energy generated by the latter being capable of either being stored in an accumulator or of being converted into heating energy which is stored in a thermal system.

Since this valve performs both the function of a shut-off valve and the function of a reducing valve, it can be used in a multiplicity of industrial installations, in order to recover and utilize energy which has hitherto been wasted. The control of the rotation of the rotor 2 and consequently the control of the reducing valve are carried out via an electrical circuit acting on the electrical generator.

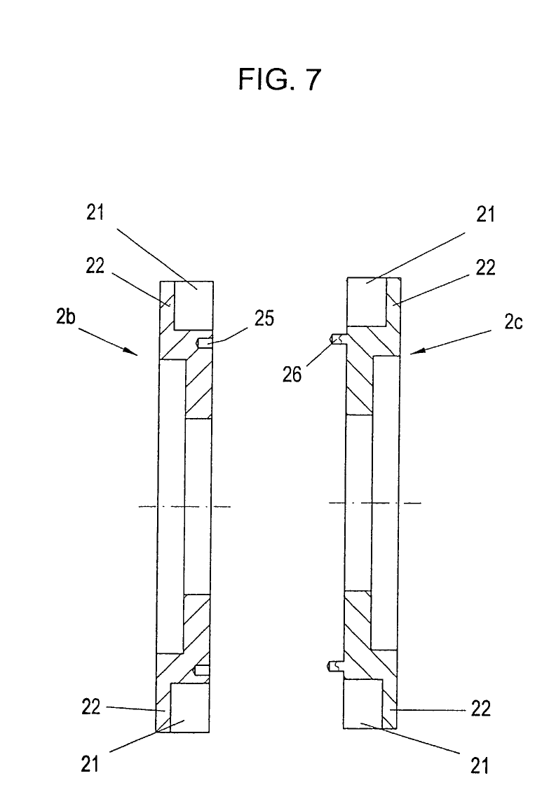

As also illustrated in FIG. 7, the rotor may consist of two approximately symmetric parts 2b and 2c, the part 2b being produced with bores 25 and the part 2c with pins 26 which are assigned to the part 2b and by means of which said parts can be connected to one another. A simplification in the production of these components is thereby achieved. It must be remembered, in this context, that components made of ceramic material can be produced only by pressing.

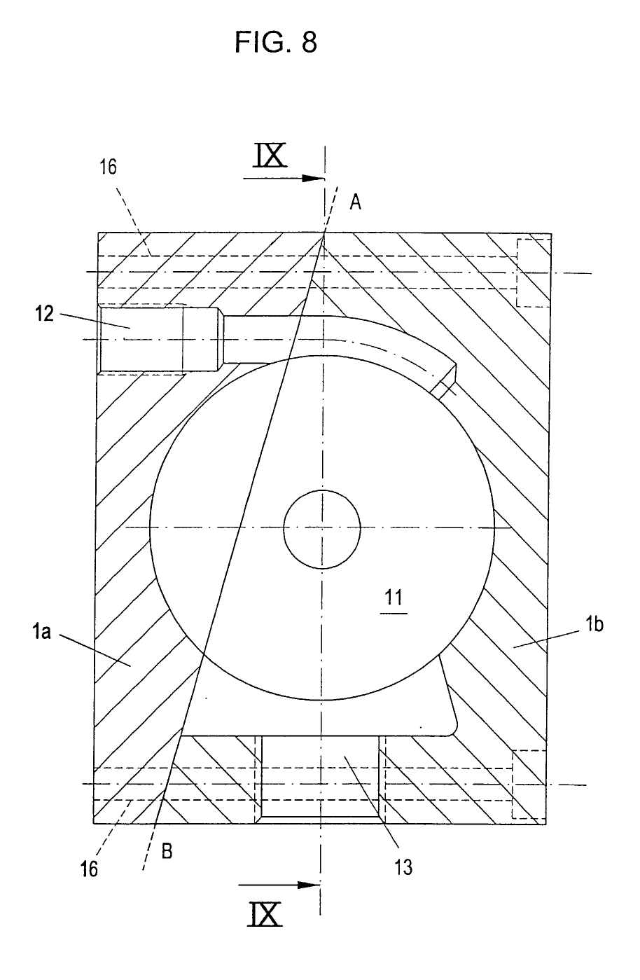

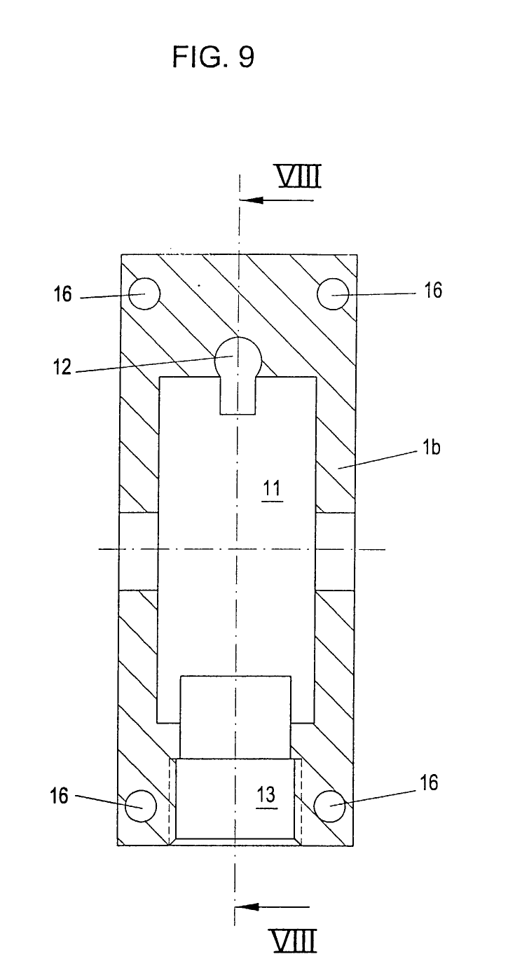

As may also be seen from FIGS. 8 and 9, the casing may be subdivided along the line A-B into two approximately parallelepipedic components 1a and 1b which in each case are designed with a part-cylindrical recess. These two components 1a and 1b are produced with bores 16, into which tension bolts can be inserted. Furthermore, the two components 1a and 1b are produced with recesses for forming the inflow duct 12 and the outflow duct 13.

In this configuration, the rotor can be inserted into the part-cylindrical recesses which are thereupon connected to one another by means of the tension bolts inserted into the bores 16.

I claim:

1. A valve, comprising:
a casing of ceramic material having a cylindrical cavity formed therein with a peripheral cavity surface and end faces, an inflow duct for a pressurized medium communicating with said cavity and an outflow duct for the medium flowing out with reduced pressure communicating with said cavity;
a rotor of ceramic material received in said cylindrical cavity;
said rotor being a cylindrical body with end faces and a peripheral rotor surface formed with a multiplicity of recesses at a spacing distance from one another in a direction of rotation, said peripheral rotor surface, in regions thereof between said recesses, sealingly bearing against said peripheral cavity surface in said casing, and said end faces of said rotor sealingly bearing against said end faces of said casing.

2. The valve according to claim 1, wherein said rotor is configured to resist a flow from said inflow duct to said outflow duct to render the valve a pressure reducing valve.

3. The valve according to claim 1, wherein said recesses in said rotor are radially oriented grooves.

4. The valve according to claim 1, wherein said recesses are formed with lateral cheeks, such that said recesses are open only radially outward.

5. The valve according to claim 1, wherein said inflow duct and said outflow duct are arranged approximately diametrically opposite one another relative to said cylindrical cavity.

6. The valve according to claim 1, wherein said rotor is formed with a central opening, and a coupling element of elastic material is inserted into said central opening receiving a shaft passing through said casing.

7. The valve according to claim 6, wherein said coupling element is a sleeve produced from elastic material.

8. The valve according to claim 1, wherein said casing is a two-part casing with a first part formed with said cylindrical cavity, said inflow duct, and said outflow duct, and with a second part formed as a cover plate.

9. The valve according to claim 8, wherein said two-part casing is a substantially square body.
